(19) United States
(12) Patent Application Publication
(10) Pub. No.: US 2023/0026119 A1
(43) Pub. Date: Jan. 26, 2023

(54) SMART MUSCLE MASSAGE APPARATUS

(71) Applicant: STRIG Inc., Seongnam-si (KR)

(72) Inventor: Hwankyung OH, Yongin-si (KR)

(21) Appl. No.: 17/469,775

(22) Filed: Sep. 8, 2021

(30) Foreign Application Priority Data
Jul. 23, 2021 (KR) 10-2021-0097056

(51) Int. Cl. A61H 7/00; A61H 23/02

(52) U.S. Cl. CPC A61H 7/003; A61H 23/02; A61H 2230/085; A61H 2201/5071

(57) ABSTRACT

A smart muscle massage system includes a blade plate including an exposed blade and an inner beam for discharging microcurrent, a main board electrically connected to the inner beam, a battery electrically connected to the main board, a housing for fixing the inner beam and for mounting the main board and the battery and including a blade cover and a handle cover part, a connector electrically connected to with the exposed blade and exposed via the handle cover part, and a diagnostic module electrically connected to the main board to diagnose state of muscle according to pressure of the muscle and attached to lower end of the handle cover part.

### BACKGROUND OF THE INVENTION

### 1. Field of the Invention

The present invention relates to a smart muscle massage system capable of acquiring and analyzing data on a muscle state while effectively performing a muscle massage.

### 2. Description of the Related Art

When a problem such as inflammation or twist occurs in a muscle, a taut band is generated in the muscle. This reduces muscle elasticity and causes pain. In order to remove these bands, it is necessary to regularly rub or vibrate the muscles with an appropriate force.

Methods of massaging muscles using hands, such as massage, put a strain on the operator's hand, and it is difficult to remove the deep muscle band. In addition, it is very difficult to find a professional operator. In addition, even if there is a massager that performs self-treatment, there are many cases where beginners cannot easily know the treatment area or the interval between treatment.

### SUMMARY OF THE INVENTION

### Problem to be Solved by the Invention

The present invention has been devised to solve the above-mentioned conventional problems, and a purpose of the present invention is providing a smart muscle massage system to obtain data on a muscle state and analyze it while effectively performing a muscle massage.

### Means for Solving the Problem

The present invention provides a smart muscle massage system. The system includes a blade plate including an exposed blade and an inner beam for discharging microcurrent, a main board electrically connected to the inner beam, a battery electrically connected to the main board, a housing for fixing the inner beam and for mounting the main board and the battery and including a blade cover and a handle cover part, a connector electrically connected to with the exposed blade and exposed via the handle cover part, and a diagnostic module electrically connected to the main board to diagnose state of muscle according to pressure of the muscle and attached to lower end of the handle cover part.

In one embodiment, the diagnostic module may include a diagnostic module upper case and a diagnostic module lower case. An outer wall surrounding a lower part of the handle cover part is formed on the diagnostic module upper case. An opening for a USB terminal is formed in the diagnosis module upper case.

In one embodiment, a hole for a pressure application rod may be formed on a surface of the diagnosis module lower case.

In one embodiment, the diagnostic module includes a pressure sensor for measuring muscle pressure; a pressure applying rod for applying pressure to the pressure sensor in contact with skin; and a pressure control circuit converting a pressure value according to muscle pressure measured by the pressure sensor.

In one embodiment, the pressure control circuit divides the pressure value according to a certain weight into constant intervals, and converted into a corresponding pressure value in proportion to an applied pressure.

In one embodiment, the system may further include an analysis module receiving muscle pressure value diagnosed by the diagnosis module and analyzing state of the muscle.

In one embodiment, the analysis module stores pressure value for each of body muscles, classifies pain level for the muscle pressure value, visualizes and outputs pain level for the input muscle pressure value, and provides statistical analysis on state for the each of the body muscles.

In one embodiment, the analysis module provides a means for accessing content for exercise method of body part in which pain is sensed.

In one embodiment, the system may further include a motor unit electrically connected to the main board and generating vibration. The analysis module provides at least one vibration pattern according to the muscle pressure value measured by the diagnosis module.

In one embodiment, discharge amount of microcurrent is adjusted according to muscle state diagnosed by the diagnosis module.

In one embodiment, the main board includes a current measuring unit for measuring amount of discharge of the microcurrent; and a transmitter for transmitting the measured discharge amount of the microcurrent. muscle state of patient is analyzed based on the amount of the measured microcurrent released.

### BRIEF DESCRIPTION OF THE DRAWINGS

FIG. 1 is a perspective view showing a smart muscle massage system according to an embodiment of the present invention.

FIG. 2 is a perspective view showing a blade plate of the smart muscle massage system according to the embodiment of FIG. 1.

FIG. 3 is a plan view showing the internal components of the smart muscle massage system according to the embodiment of FIG. 1.

FIG. 4 is a perspective view illustrating a housing coupling state of the smart muscle massage system according to the embodiment of FIG. 1.

FIG. 5 is an exploded perspective view of the diagnostic module according to another embodiment of the present invention.

FIG. 6 is an analysis module screen diagram showing a screen provided by the analysis module in the application.

FIG. 7 is a concept view illustrating a system with a massage apparatus according to another embodiment of the present invention.

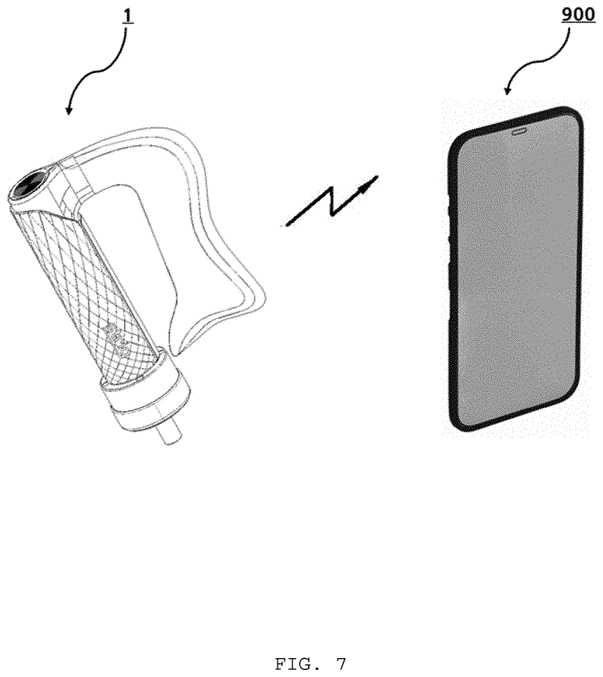

### DETAILED DESCRIPTION OF THE PREFERRED EMBODIMENT

Hereinafter, a preferred embodiment with reference to the accompanying drawings will be described with reference to the accompanying drawings. In this process, the thickness of the lines or the size of the components shown in the drawings may be exaggerated for clarity and convenience of explanation. In addition, the terms to be described below are terms defined in consideration of the functions in the present invention, which are intended by users and operators.

It may vary depending on the province or custom. Therefore, definitions of these terms should be made based on the content throughout this specification.

In addition, the following examples are not intended to limit the scope of the present invention, but merely to provide an example, and there may be various embodiments implemented through the present technical idea.

Configuration of Smart Muscle Massage Apparatus

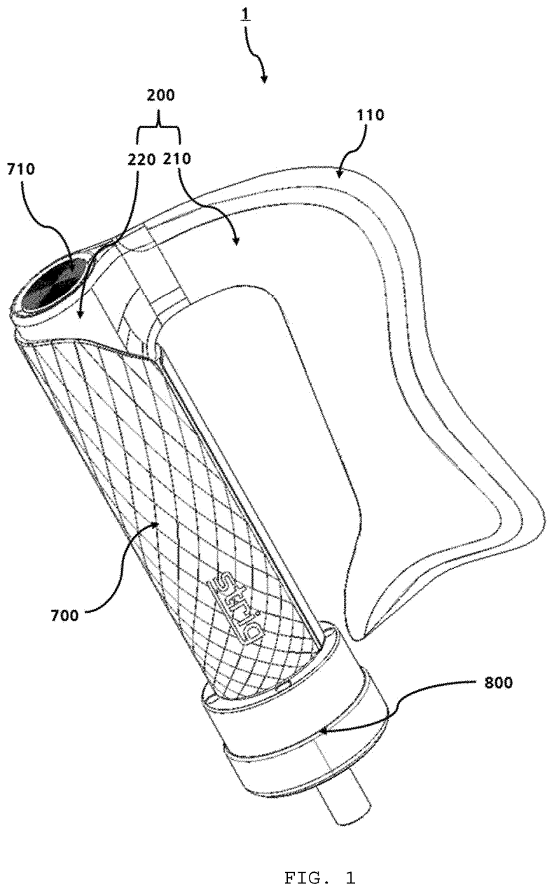

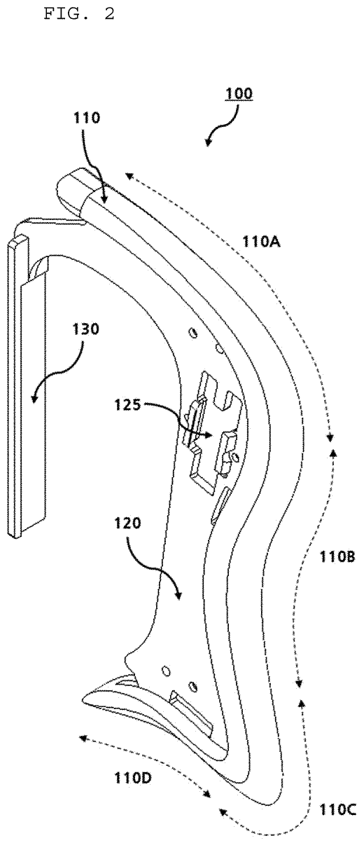

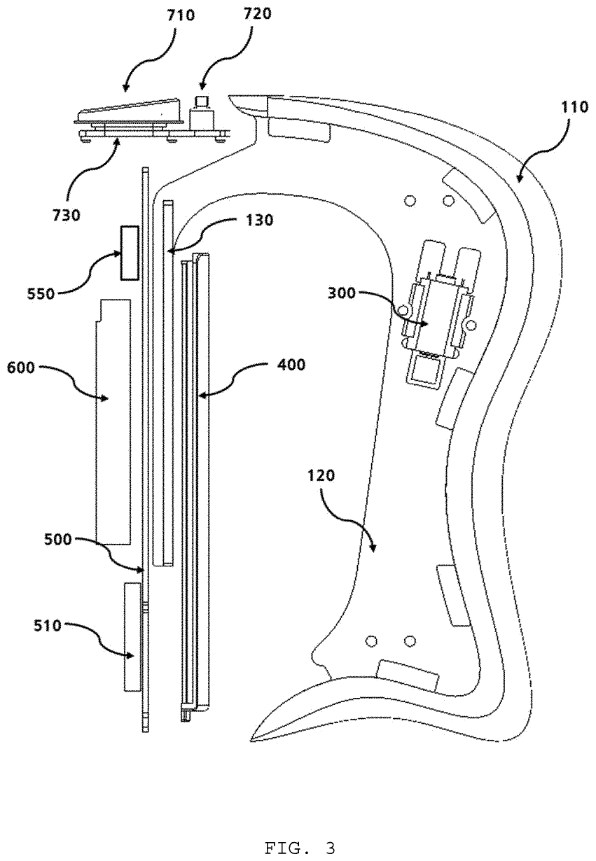

FIG. 1 is a perspective view showing a smart muscle massage system according to an embodiment of the present invention. FIG. 2 is a perspective view showing a blade plate of the smart muscle massage system according to the embodiment of FIG. 1. FIG. 3 is a plan view showing the internal components of the smart muscle massage system according to the embodiment of FIG. 1.

Referring to FIGS. 1 to 3, the smart muscle massage system1 includes a blade plate 100, a main board 500, a battery 600 electrically connected to the main board 500, a housing 200 and a diagnostic module 800.

In addition, the smart muscle massage system1 may further include motor unit 300 and a connector 400. The motor unit 300 is electrically connected to the main board 500 and generates vibration. The connector 400 is electrically connected to the exposure blade 110 through the inner beam 130.

In this way, the separation of the configuration of the smart muscle massage system1 into a basic configuration and an additional configuration can be implemented with the minimum configuration requirements in practicing the present invention, The smart muscle massage system1 can be functionally divided into one part supplying micro-current and the other part generating vibration. The apparatus can be modified with these minimum configuration requirements having only one part of the microcurrent part and the vibrating part.

The blade plate 100 basically includes an exposed blade 110 and an inner beam 130 for discharging a microcurrent that performs a minimal function. The exposed blade 110 is a part in direct contact with the recipient, and is made of metal or plating, so that a microcurrent can be delivered to the recipient. Conversely, the inner beam 130 is the main substrate

It is electrically connected to 500 to supply a microcurrent to the exposed blade 110.

The connector 400 is electrically connected to the exposed blade 110 through the inner beam 130 and allows a microcurrent supplied from the main board 500 to flow into the recipient. The battery 600 is electrically connected to the main board 500 and supplies necessary power. The housing 200 fixes the inner beam 130 and mounts the battery 600, the main board 500 and other internal components.

The motor unit 300 is electrically connected to the main board 500 and is disposed in the blade plate 100 to transmit the generated vibration. In addition to the motor unit 300 can be installed in the handle cover part 220 of the housing 200 or can be formed in a removable manner.

Configuration of the Blade Plate

Referring to FIG. 2, the blade plate 100 includes an exposed blade 110 and an inner beam 130, and further includes a body plate 120. The exposure blade 110 contacts directly to the person receiving the treatment, and the inner beam 130 plays a role of electrically connecting to the main board 500.

In some embodiment, it is possible to provide a configuration in which the body plate 120 is omitted and only the exposed blade 110 and the inner beam 130 are supplied with a microcurrent if necessary.

The body plate 120 mechanically connects the exposed blade 110 and the inner beam 130. In one embodiment, the exposed blade 110, the body plate 120, and the inner beam 130 may be formed of a single metal. For example, the blade plate 100 integrally formed in this way may be made of brass. The exposed blade 110 in contact with the operator may be subjected to a separate plating process.

The blade plate 100 may be manufactured by forming the exposed blade 110, the body plate 120, and the inner beam 130 of different materials, respectively, and combining them. For example, the exposed blade 110 and the inner beam 130 may be formed of an integral metal, and the body plate 120 may be formed of a non-metal material. For example, it may be formed of a polymer or silicone material. Since the exposed blade 110 and the inner beam 130 have a function of electrically conducting and transmitting a microcurrent. The body plate 120 mechanically connect and adjust the center of gravity. If necessary, higher or lower density non-metallic materials can be used to simplify the size of the product or to be modified and designed to add additional functions.

The body plate 120 includes a mounting opening 125 in which the motor unit 300 can be mounted. The body plate 120 includes a significant weight in the blade plate 100. The center of gravity in the overall smart muscle massage system1 is drawn toward the blade plate 100. Therefore, this center of gravity design allows the operator to perform the operation more conveniently. Since the motor is mounted in the mounting opening 125 formed in the body plate 120, the vibration of the motor unit 300 is generated in the front part of the blade and can directly transmit the vibration to the treatment target. In this case, a small vibration motor is used so that it can be mounted in the blade plate 100 formed in a narrow blade shape.

For example, when the motor is seated in the handle cover part 220 of the housing 300, a larger motor can be inserted. Since it is transmitted to the operator's hand rather than to the recipient's hand, the transmission efficiency of vibration is reduced. The operator has a disadvantage that such vibration is transmitted through the hand, so that the operation must be performed in an inconvenient environment.

If necessary, one to two or more of these motor units 300 can be arranged. By changing the structure of the body plate 120, various motors can be arranged while maintaining the situation in which the center of gravity is in the front.

The Curved Structure of the Blade Plate

Referring to FIG. 2, the exposed blade 110 has a first surface 110A, a second surface 110B, a third surface 110C, and a fourth surface 110D to contact with the skin of the recipient. Each of these curved surfaces has a different characteristic shape, so when performing massage, it is possible to perform the treatment while using different surfaces depending on the treatment target.

The first surface 110A includes the protruding curved surface of the largest radius. The second surface 110B is formed continuously with the first surface 110A and extends in the longitudinal direction of the exposed blade 110 and includes a depressed curved surface. The third surface 110C is formed continuously with the second surface 110B and includes a protruding corner curved surface. The fourth surface 110D is formed continuously with the third surface 110C and is extended in a direction substantially perpendicular to the second surface 110B and includes a recessed curved surface.

The first surface 110A and the third surface 110C include protruding curved surfaces and can be used when a massage is performed by focusing on a specific area. The third surface 110C can be used in a much more concentrated area, with compared to the first surface 110A. The second surface 110B and the fourth surface 110D include recessed curved surfaces and may be used to massage protruding parts such as arms and legs. Compared to the second surface 110B, the fourth surface 110D can be used in a much narrower area.

In particular, the fourth surface 110D can be formed to be spaced apart from the housing 200. The open blade structure allows the operator to grip in a more convenient direction.

Housing Coupling Structure

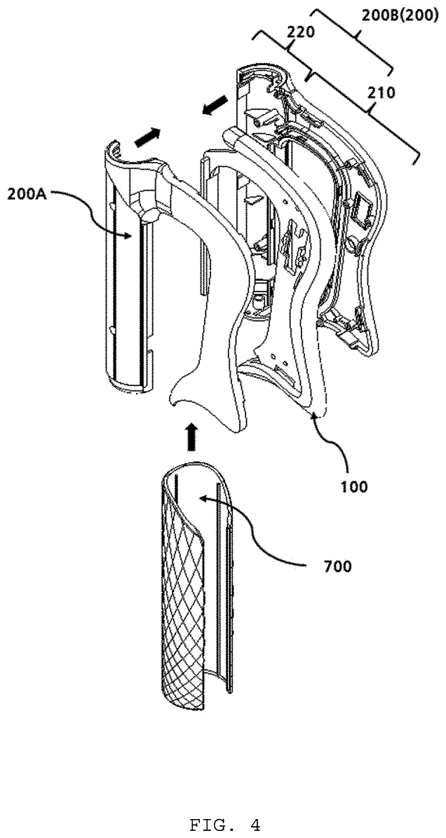

FIG. 4 is a perspective view illustrating a housing coupling state of the smart muscle massage system according to the embodiment of FIG. 1.

Referring to FIGS. 1 to 4, the housing 200 may include a blade cover part 210 and a handle cover part 220. The blade cover part 210 covers the body plate 120 so as not to be exposed. The handle cover part 220 houses the part held by the operator.

In general, the blade cover part 210 and the handle cover part 220 are integrally formed. the blade cover part 210 and the handle cover part may be designed separately by dividing these into two components. In a modified embodiment, the housing 200 may include only one of the blade cover part 210 or the handle cover part 220.

For example, in another embodiment, the housing 200 may be formed with only the handle cover part 220. At this time, since the blade cover part 210 does not exist, it is possible if the entire blade is exposed or the body plate 120 covered by the blade cover part 210 is omitted.

The blade cover part 210 covers the body plate 120. The handle cover part 220 covers the main board 500 and the battery 600. The handle cover part 220 fixes the inner beam 130 in a mechanical structure.

In general, the blade cover portion 210 and the handle cover portion 220 are integrally formed and may be formed of various materials. For example, ABS material or PC material can be used.

Referring to FIG. 4, in the embodiment of FIG. 4, it may further include a grip part 700 which is slidably coupled to the handle cover part 220 of the housing 200 and is also detachable.

The grip part 700 is a part held in the operator's hand. When the housing 200 is divided into two left and right parts 200A and 200B, the grip part 700 can be manufactured separately for its own material or configuration. The grip part 700 may be made of ABS and rubber or ABS and elastomer, and in some cases, the grip part may be made of leather on the surface, so that various changes are possible according to the operator's preference.

The connector 400 is exposed to the handle cover 220 of the housing 200. The connector 400 serves to be electrically connected to the operator, and the connector 400 is electrically conductive with the exposure blade 110 through the inner beam 130. In order to supply a microcurrent to a person receiving a massage through the exposure blade 110, a path through which the current can flow must be secured, and this is possible by securing a path electrically connected to the operator. Therefore, the connector 400 is required to supply a microcurrent.

The connector 400 may be disposed to be exposed on one side of the handle cover part 220. The connector 400 may be formed in a region held by a massage operator and electrically connected while holding the hand.

Muscle Diagnosis Function by Measuring Muscle Current

Referring to FIG. 1, a switch 710 of a device capable of controlling the generation of microcurrent and vibration may be formed at the top of the handle cover 220 of the housing 200. The operator can control the operation by easily pressing the switch 710 using the thumb when holding it in the grip part 700.

An LED display unit 720 may be formed in an area adjacent to the switch 710, which may serve to display an operating state or inform the remaining amount of a battery. The LED display unit 720 may display various situations, such as sufficient battery, insufficient remaining battery, battery warning, normal operation, and occurrence of a failure, with a color or a blinking pattern. The switch 710 and the LED display unit 720 may be controlled through the sub-board 730 positioned below.

The switch 710 may control the smart muscle massage system1, the diagnostic module 800, and the analysis module 900 according to the touch type, including the touch sensor. That is, when the switch 710 is touched for a long time, it is possible to adjust whether current is discharged to the blade. When the switch 710 is briefly touched, it may be provided to variously change the discharge pattern of current. And when the switch 710 is briefly touched twice, the diagnosis module 800 is prepared for operation, and the analysis module 900 connected to the smart muscle massage system1 and Bluetooth is switched on. It can also be controlled to run on a mart mobile device. The LED display unit 720 displays the pressure value obtained from the diagnosis module 800.

In addition, the main board 500 includes a current measurement unit 550 for measuring the amount of current of the microcurrent and a transmitter 510 for transmitting the measured current value. The main board 500 transmits the measured amount of current. This can be used as data to observe the condition of the recipient's fascia. In addition, the accumulated data can be used as data to analyze the condition change or condition of the operator. The current measuring unit 550 may measure each amount of current according to the blade surface. For example, the current measuring unit 750 may measure the amount of current according to the first surface 110A, the second surface 110B, the third surface 110C, and the fourth surface 110D in contact with the skin.

The transmitter 510 transmits data to the analysis module 900 through various mobile devices.

It may include a diagnosis module 800 and an analysis module 900 for more accurate analysis of the muscle state.

Muscle Diagnosis Function by Measuring Muscle Pressure

(a) Diagnostic Module

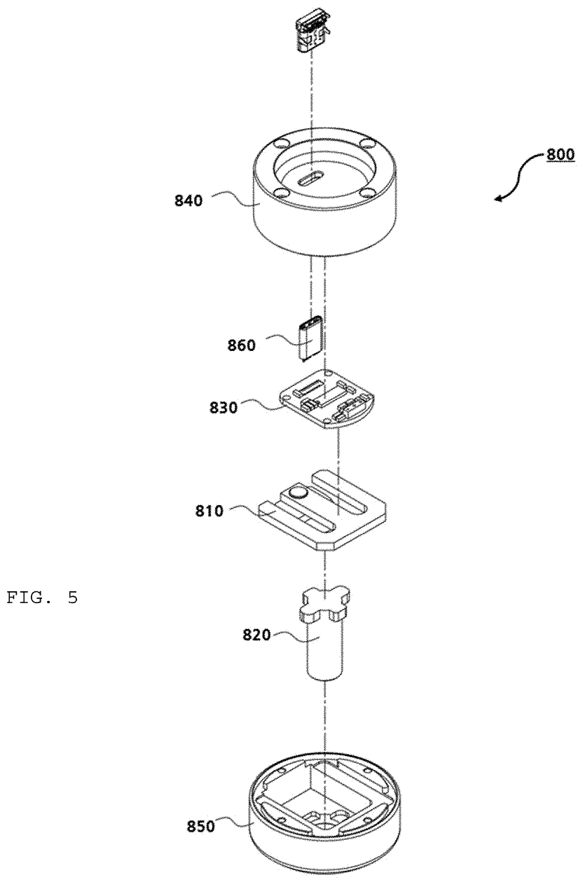

FIG. 5 is an exploded perspective view of the diagnostic module according to another embodiment of the present invention. The diagnostic module 800 is combined to the lower part of the handle cover part 220. The diagnosis module 800 includes a diagnosis module upper case 840 and a diagnosis module lower case 850. An outer wall surrounding the lower end of the handle portion of the housing 200 is formed on the circumference of the diagnostic module upper case 840. An opening through which the USB terminal passes is formed in the upper case 840 of the diagnostic module. The diagnostic module lower case 850 is coupled to the diagnostic module upper case 840. A hole through which the pressure applying rod 820 passes is formed on the surface of the lower case 850 of the diagnostic module. By forming an outer wall surrounding the lower end of the handle portion of the housing 200 on the circumference of the upper case 840 of the diagnosis module, the body of the smart muscle massage system1 and the diagnosis module 800 can be firmly fixed.

The diagnosis module 800 can diagnose and measure a state of a muscle. The diagnostic module 800 may be provided as a module separate from the housing combination. The diagnostic module 800 includes an upper case 840 and a lower case 850. The diagnostic module 800 may include a pressure sensor 810. The diagnostic module 800 further includes a pressure application rod 820 and a pressure control circuit 830. The pressure application rod 820 is contacted with the muscle. The pressure control circuit 830 electrically receives the pressure value obtained from the pressure application rod 820 and transmits it to the main board 500. The pressure control circuit 830 includes a USB connection unit 860 electrically connected to the main board. The diagnosis module 800 may be manufactured in a shape corresponding to the shape of the lower end of the handle cover part 220.

The diagnostic module 800 is a USB (Universal Serial Bus) can be connected. The diagnostic module 800 may be electrically connected to the main board 500 by a USB. The diagnostic module 800 may receive power from the battery 600 and may independently include a battery.

(b) Pressure Value Conversion Setting of the Pressure Control Circuit

The pressure sensor 810 measures the muscle pressure by measuring the capacitance according to the displacement changed according to the applied pressure. The pressure sensor 810 measures the pressure and transmits the calculated pressure value to the pressure control circuit 830. The pressure control circuit 830 sends the pressure value to the main board 500 through the USB. The pressure sensor 810 measures the pressure by pressing the pressure applying rod 820 connected to the pressure sensor 810 on the skin.

However, there is a problem that the capacitance according to the displacement does not change proportionally. Therefore, the pressure control circuit 830 serves to solve this problem. The pressure control circuit 830 converts the value so that the pressure according to the capacitance is proportional. Thereby, the pressure control circuit 830 is set so that the interval is the same for each pressure step. For this setting, experimentally prepare table values for displacement according to a predetermined weight. And the pressure control circuit 830 converts the pressure value using the table value so that the pressure value according to the displacement change is proportional to the weight.

The maximum pressure operation area of the pressure sensor 810 is previously set. This is to check the weight that the pressure sensor 810 can bear to the maximum. The pressure sensor 810 is provided to measure a pressure of at least 3 Kg. In addition, the pressure sensor 810 may transmit a pressure value measured at a report rate of at least 100 Hz to the pressure control circuit 830. The report rate is provided so that it can be set in an external computer connected to the massage device body or an application on a smart mobile device.

The pressure control circuit 830 may be set so that the pressure value measured by the pressure sensor 810 is divided into steps to divide the pressure into 3 to 10 steps of resolution. For example, by setting the measured pressure to 1 level per 300 g, the muscle pain according to the measured pressure on the muscle can be quantified. The degree of muscle pain according to the measured pressure may be programmed in the memory of the pressure control circuit 830 and stored as data. The pressure control circuit 830 may transmit a pressure value measured based on the stored data to the transmitter 510 of the main board 500. Alternatively, the pressure control circuit 830 may transmit a value divided by a resolution of 3 to 10 to the transmitter 510. The transmitter 510 may transmit the measured pressure value itself to the analysis module 900 and may transmit the pressure value converted by the pressure control circuit 830 to the analysis module 900.

Provide Analysis Module

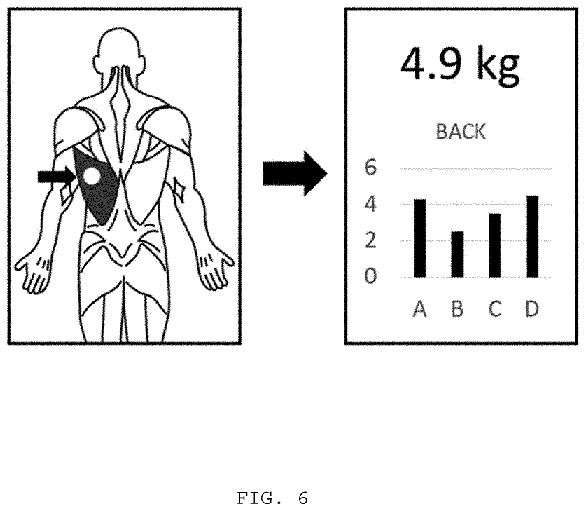

FIG. 6 is an analysis module screen diagram showing a screen provided by the analysis module in the application. The transmitter 510 included in the main board may transmit the pressure value to the analysis module 900. The analysis module 900 may be included in the smart muscle massage system1. The analysis module 900 may be provided as an application included in a mobile device such as a smartphone.

The transmission of the pressure value from the transmitter 510 of the main board 500 to the analysis module 900 may be performed by a Bluetooth communication method. When the switch 710 operates or when pressure is applied to the pressure application rod 820, the analysis module 900 as a separate device is automatically turned on and operated, or the application may be provided to be automatically executed. When the switch 710 operates or pressure is applied to the pressure applying rod 820, a separate device and application may be automatically executed through the Bluetooth device of the main board 500.

The analysis module 900 may control the smart muscle massage system1 on a separate device or application. The analysis module 900 may control the amount of current discharged by the smart muscle massage system1. The analysis module 900 can control the current discharge position, the vibration pattern, the resolution of the pressure sensor 810, the pressure recognized by the pressure sensor 810 as maximum.

The analysis module 900 may be provided as an application of a smartphone. When the analysis module 900 is provided as an application software, a Bluetooth device and a Wi-Fi device of the smartphone may be used. The transmitter 510 of the main board 500 and the Bluetooth device of the analysis module 900 may communicate. The transmitter 510 uses a Bluetooth device included in the main board 500. The smart muscle massager 1 and the analysis module 900 may communicate with each other through Bluetooth communication.

The analysis module 900 provided as an application of the smartphone may provide a control button for controlling the smart muscle massager 1 to the user as an icon. The user uses the control button on the smartphone application, the amount of current discharged by the smart muscle massager 1, the current discharge position, the vibration pattern, the resolution of the pressure sensor 810, the pressure recognized by the pressure sensor 810, etc. can be controlled.

Provide Status Information and Treatment Information for Each Body Part

Referring to FIG. 6, the analysis module 900 provides a human body diagram divided by body parts to a recipient or an operator. The analysis module 900 provides for selecting the front and rear surfaces of the human body in the anatomical diagram. In FIG. 6, the analysis module 900 provides to select a plurality of divided body regions from the back of the human body. When the divided body region is selected, the analysis module 900 magnifies the selected body part and provides time to measure the pressure so that the operator can measure the pressure. The analysis module 900 visualizes and shows the degree of pain according to the pressure value transmitted by the transmitter to the operator or the operator. The analysis module 900 may cause the motor unit 300 to provide at least one vibration pattern according to the muscle pressure value measured by the diagnosis module 800.

The analysis module 900 according to an embodiment quantifies and shows the pressure value in Kg unit with the measured time. The analysis module 900 may divide the level of pain into mild, moderate, and severe. The module 900 lets the recipient intuitively know.

The analysis module 900 may store data such as a pressure value or personal information of a recipient. Also, the analysis module 900 may store the received current value together with the pressure value. The analysis module 900 may store current values according to body parts. The analysis module 900 may store the muscle pressure value transmitted by the transmitter for each part of the body. At this time, the analysis module 900 and the database may be linked to store data.

The analysis module 900 may store a muscle pressure value and a current value according to the measured time and provide statistical visualization of the pressure value and the current value according to the stored date.

In addition, the analysis module 900 may also receive and store the current value measured by the current measuring unit 550 and transmitted by the transmitting unit. The analysis module 900 may diagnose the state of the muscle according to a table indicating the state of the muscle according to the current value.

One embodiment of the present invention described above is merely exemplary, and those of ordinary skill in the art to which the present invention pertains will be aware that various modifications and equivalent other embodiments are possible therefrom. will be able Therefore, it will be well understood that the present invention is not limited to the form mentioned in the above detailed description. Therefore, the true technical protection scope of the present invention should be determined by the technical spirit of the appended claims. Moreover, it is to be understood that the present invention covers all modifications, equivalents and substitutions falling within the spirit and scope of the invention as defined by the appended claims.

### EXPLANATION OF REFERENCE NUMERALS

100: blade plate
110: exposed blade
110A: first side
1108: second side
110C: 3rd side
110D: 4th side
120: body plate
125: mounting opening
130: inner beam
200: housing
210: blade cover
220: handle cover part
300: motor unit
400: connector
500: main board
510: transmitter
600: battery
700: grip part
710: switch
720: LED display
730: sub board
800: diagnostic module
810: pressure sensor
820: pressure application rod
830: pressure control circuit
840: diagnostic module upper case
850: diagnostic module lower case
860: USB terminal
900: analysis module

What is claimed is:

1. A smart muscle massage system comprising:
a blade plate 100 including an exposed blade 110 and an inner beam 130 for discharging microcurrent;
a main board 500 electrically connected to the inner beam 130;
a battery 600 electrically connected to the main board 500;
a housing 200 for fixing the inner beam 130 and for mounting the main board 500 and the battery 600 and including a blade cover 210 and a handle cover part 220;
a connector 400 electrically connected to with the exposed blade 110 and exposed via the handle cover part 220; and
a diagnostic module 800 electrically connected to the main board to diagnose state of muscle according to pressure of the muscle and attached to lower end of the handle cover part 220.

2. The massage system according to claim 1,
wherein the diagnostic module 800 comprises a diagnostic module upper case 840 and a diagnostic module lower case 850
wherein an outer wall surrounding a lower part of the handle cover part 220 is formed on the diagnostic module upper case 840,
and wherein an opening for a USB terminal is formed in the diagnosis module upper case 840.

3. The massage system according to claim 2,
wherein a hole for a pressure application rod 820 is formed on a surface of the diagnosis module lower case 850.

4. The massage system according to claim 1,
wherein the diagnostic module 800 includes a pressure sensor 810 for measuring muscle pressure; a pressure applying rod 820 for applying pressure to the pressure sensor in contact with skin; and a pressure control circuit 830 converting a pressure value according to muscle pressure measured by the pressure sensor 810.

5. The massage system according to claim 4,
wherein the pressure control circuit 830 divide the pressure value according to a certain weight into constant intervals, and converted into a corresponding pressure value in proportion to an applied pressure.

6. The massage system according to claim 1,
further comprising an analysis module 900 receiving muscle pressure value diagnosed by the diagnosis module 800 and analyzing state of the muscle.

7. The massage system according to claim 6,
wherein the analysis module 900 stores pressure value for each of body muscles,
classifies pain level for the muscle pressure value,
visualizes and outputs pain level for the input muscle pressure value, and
provides statistical analysis on state for the each of the body muscles.

8. The massage system according to claim 7,
Wherein the analysis module 900 provides a means for accessing content for exercise method of body part in which pain is sensed.

9. The massage system according to claim 7,
further comprising a motor unit 300 electrically connected to the main board 500 and generating vibration,
wherein the analysis module 900 provides at least one vibration pattern according to the muscle pressure value measured by the diagnosis module 800.

10. The massage system according to claim 1,
wherein discharge amount of microcurrent is adjusted according to muscle state diagnosed by the diagnosis module 800.

11. The massage system according to claim 1,
wherein the main board 500 includes a current measuring unit for measuring amount of discharge of the microcurrent; and a transmitter for transmitting the measured discharge amount of the microcurrent;
wherein muscle state of patient is analyzed based on the amount of the measured microcurrent released.
